(19) United States
(12) Patent Application Publication
(10) Pub. No.: US 2026/0118575 A1
(43) Pub. Date: Apr. 30, 2026

(54) POLARIZATION MAINTAINING MULTICORE FIBER THAT INCLUDES A STRESS APPLYING PART TO SUBSTANTIALLY EFFECT A BIREFRINGENCE IN SURROUNDING CORES

(71) Applicant: Lumentum Operations LLC, San Jose, CA (US)

(72) Inventors: Peter JAKOPIC, Videm-Dobrepolje (SI); Žan PIRNAR, Ljubljana (SI); Simonette PIERROT, Zurich (CH); Benedikt HERMANN, Zurich (CH)

(21) Appl. No.: 19/046,022

(22) Filed: Feb. 5, 2025

Related U.S. Application Data
(60) Provisional application No. 63/553,886, filed on Feb. 15, 2024.
(60) Provisional application No. 63/660,779, filed on Jun. 17, 2024.

(51) Int. Cl. G02B 6/024; G02B 6/02

(52) U.S. Cl. CPC G02B 6/024; G02B 6/02042

(57) ABSTRACT

In some implementations, an optical system includes a multicore fiber that includes: a cladding; a stress applying part (SAP); and a set of at least three cores that, at a cross-section of the multicore fiber, are equidistant from a center of the SAP, wherein the SAP substantially effects a birefringence in the set of at least three cores.

### CROSS-REFERENCE TO RELATED APPLICATION

This patent application claims priority to U.S. Patent Application No. 63/660,779, filed on Jun. 17, 2024, and entitled “MULTICORE FIBER WITH CENTRAL STRESS ROD TO MAINTAIN POLARIZATION” and to U.S. Patent Application No. 63/553,886, filed on Feb. 15, 2024, and entitled “MULTI-CORE FIBER GEOMETRY WITHOUT THERMAL GRADIENTS FOR COHERENT BEAM COMBINING.” The disclosure of the prior applications is considered part of and is incorporated by reference into this patent application.

### TECHNICAL FIELD

The present disclosure relates generally to a polarization maintaining (PM) multicore fiber and to a PM multicore fiber that includes a stress applying part (SAP) to substantially effect a birefringence in surrounding cores.

### BACKGROUND

A PM multicore fiber is designed to maintain polarization of signals (i.e., light) that travel via multiple cores of the multicore fiber. A PM multicore fiber, due to multiple cores, can support a high signal capacity (e.g., a high data transmission capacity), and, due to polarization maintaining properties, can maintain polarized signal light.

### SUMMARY

In some implementations, an optical system includes a multicore fiber that includes: a cladding; an SAP; and a set of at least three cores that, at a cross-section of the multicore fiber, are equidistant from a center of the SAP, wherein the SAP substantially effects a birefringence in the set of at least three cores.

In some implementations, an optical system includes a multicore fiber that includes: a cladding; an SAP; and a set of at least three cores that surround the SAP, wherein the SAP substantially effects a birefringence in the set of at least three cores, and wherein respective principal axes of polarization of the set of at least three cores are radially aligned with a center of the SAP.

In some implementations, a multicore fiber includes a cladding; an SAP; and a plurality of cores that are equidistant from a center of the SAP, wherein the SAP substantially effects a birefringence in the plurality of cores, and wherein a center of the SAP, and a first core and a second core, of the plurality of cores, are not collinear.

### BRIEF DESCRIPTION OF THE DRAWINGS

FIGS. 1A-1F are diagrams illustrating example implementations related to a PM multicore fiber that includes an SAP to substantially effect a birefringence in surrounding cores.

### DETAILED DESCRIPTION

The following detailed description of example implementations refers to the accompanying drawings. The same reference numbers in different drawings may identify the same or similar elements.

To enable a plurality of cores of a multicore fiber to maintain polarization (and thereby cause the multicore fiber to be a PM multicore fiber), the multicore fiber can include stress rods, of which at least two are placed within a close proximity of each core, such as in a linear formation (e.g., where a first stress rod and a second stress rod are placed on opposite sides of a core). The stress rods comprise a material that has a different thermal expansion property than that of a material of the core or the preform fiber or cladding of the multicore fiber, which applies a mechanical stress (e.g., a compressive stress or a tensile stress) to the core (e.g., as a result of a heated fiber-draw process to create the PM multicore fiber). This mechanical stress induces a birefringence in the core, which enables the core to maintain polarization of light within the core. For example, the mechanical stress may be applied to the core, causing a distortion that alters refractive indices in different directions within the core. This variation in refractive indices results in a birefringence in the core. The birefringence causes light entering the core that is polarized along a first principal axis of polarization of the core or a second principal axis of polarization of the core (e.g., that is orthogonal to the first principal axis of polarization) to be maintained within the core. The first principal axis of polarization may be one of a fast axis or a slow axis of polarization, and the second principal axis may be the other of the fast axis or the slow axis of polarization.

However, including at least two stress rods for each core of the PM multicore fiber increases a complexity of designing and forming the PM multicore fiber. For example, in some cases, a PM multicore is formed by drilling holes into a preform fiber, by inserting a corresponding core or stress rod into each hole, and by performing a fiber-draw process (e.g., to draw the preform fiber into a finalized PM multicore fiber). Consequently, ensuring a precise placement and alignment of stress rods and cores in the preform fiber is difficult. Additionally, because of impurities associated with stress rods and cores (e.g., impurities in holes in which the stress rods and the cores are inserted, or impurities in surfaces of the stress rods and the cores) and imperfections associated with the stress rods and the cores (e.g., resulting from scratches, cracks, bubbles, or other imperfections of the stress rods and the cores), failure of at least one stress rod or core is likely, which often results in the preform fiber (or finalized PM multicore fiber) being unusable and therefore discarded (i.e., being wasted). A likelihood of failure only increases as a number of stress rods and cores that are included in the preform fiber increases.

Further, including at least two stress rods for each core of the PM multicore fiber can limit a number of cores that can be included in the PM multicore fiber. This decreases a capacity of the PM multicore fiber, which can result in the PM multicore fiber not being suitable for an application (e.g., in an optical system) where higher capacity is required. In some cases, a size (e.g., a diameter) of the PM multicore fiber can be increased to include additional cores (and additional stress rods) to provide the higher capacity, but this can result in other design challenges within the optical system (e.g., based on accommodating a larger-sized PM multicore fiber).

Some implementations described herein include a multicore fiber (e.g., of an optical system). The multicore fiber includes a stress applying part (SAP) (e.g., that, at a cross-section of the multicore fiber, is disc-shaped or ring-shaped) and a plurality of cores that surround the SAP (e.g., where a center of the SAP and a first core and a second core, of the plurality of cores, are not collinear). For example, the plurality of cores may be equidistant from a center of the SAP (e.g., the plurality of cores may be positioned on a circumference of an imaginary circle that surrounds the SAP, where the imaginary circle is centered at the center of the SAP). Accordingly, the SAP (e.g., due to being surrounded by the plurality of cores) applies (or effectively applies) a mechanical stress to each core in a first direction that is radially aligned with the center of the SAP, which alters refractive axes of each core (e.g., along the first direction and along a second direction that is orthogonal to the first direction) and therefore substantially effects a birefringence in each core. Further, each core, due to the birefringence, has a first principal axis of polarization and a second principal axis of polarization that are aligned with the first direction and the second direction, respectively. In this way, the SAP substantially effects a birefringence in the plurality of cores, which causes respective first or second principal axes of the plurality of cores to be radially aligned with the center of the SAP.

The multicore fiber, by using only one SAP (e.g., that substantially effects the birefringence in the plurality of cores), is able to maintain polarization of light within the plurality of cores (e.g., when light entering the core is polarized along one of respective first principal axes of polarization or second principal axes of polarization of the plurality or cores), which causes the multicore fiber to be a PM multicore fiber. This reduces a complexity of designing and forming the multicore fiber (e.g., as compared to a typical PM multicore fiber that includes multiple stress rods). For example, because a number of SAPs that need to be included in the multicore fiber is significantly less (e.g., as compared to a typical number of stress rods), placement and alignment of the SAP and the plurality of cores in a preform fiber is less challenging. Further, a fewer number of components (e.g., due to using only one SAP and a plurality of cores) reduces a likelihood of a failure. This increases a likelihood that the multicore fiber is usable (e.g., after formation) and therefore utilized for its intended purpose.

In some implementations, due to the SAP being equidistant from the plurality of cores (e.g., because the SAP is a single, centered SAP), the SAP applies an equal (or nearly equal) mechanical stress to each core, and the birefringence created in the plurality of cores is equal (or nearly equal) across the plurality of cores (e.g., a birefringence field in each core is the same, or nearly the same, such as in a direction that is radially aligned with the center of the SAP). This is very hard to achieve in a typical PM multicore fiber that includes multiple stress rods (e.g., because each rod can apply a mechanical stress in a particular direction in more than one core when not adequately spaced from other cores, and therefore a birefringence in a particular core may be effected by any number of rods depending on the position of the particular core with the PM multicore fiber). Further, in some cases, the birefringence in the plurality of cores that is substantially effected by the SAP allows at least some of the cores, of the plurality of cores, to have principal axes of polarization that are not aligned with each other, which can reduce interference between the cores (e.g., reduce crosstalk). Thus, the multicore fiber, in some cases, provides an improved signal quality and integrity, which is beneficial in particular applications, such as high-capacity optical communication applications.

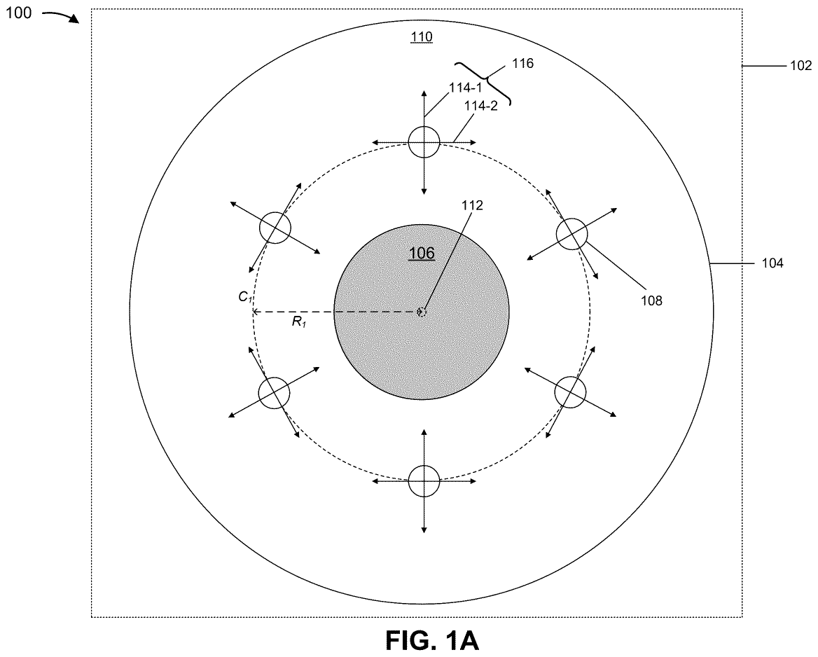

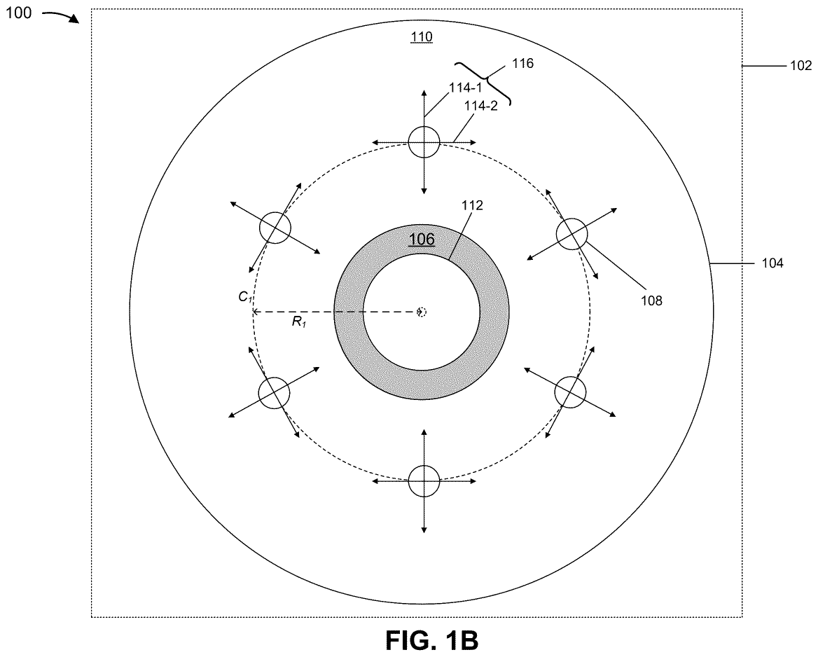

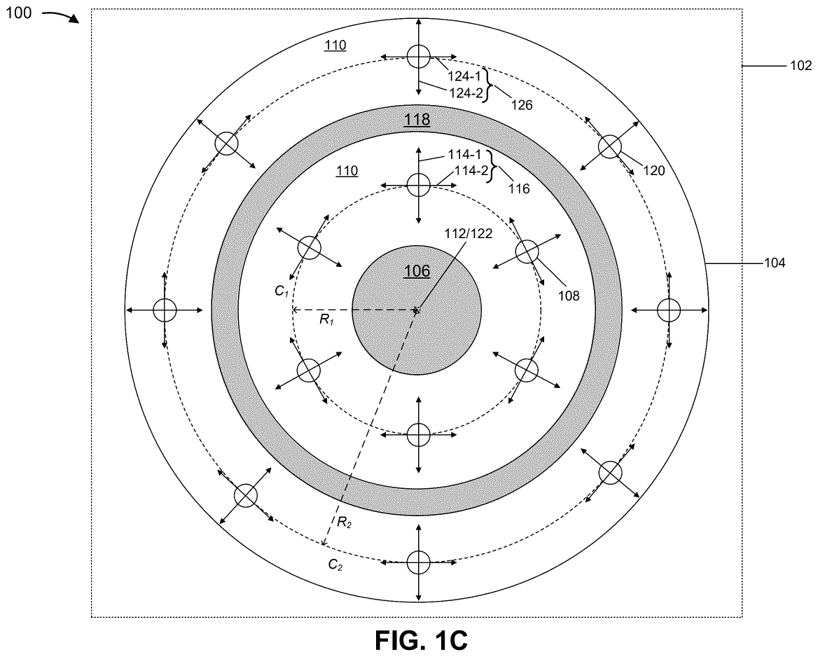

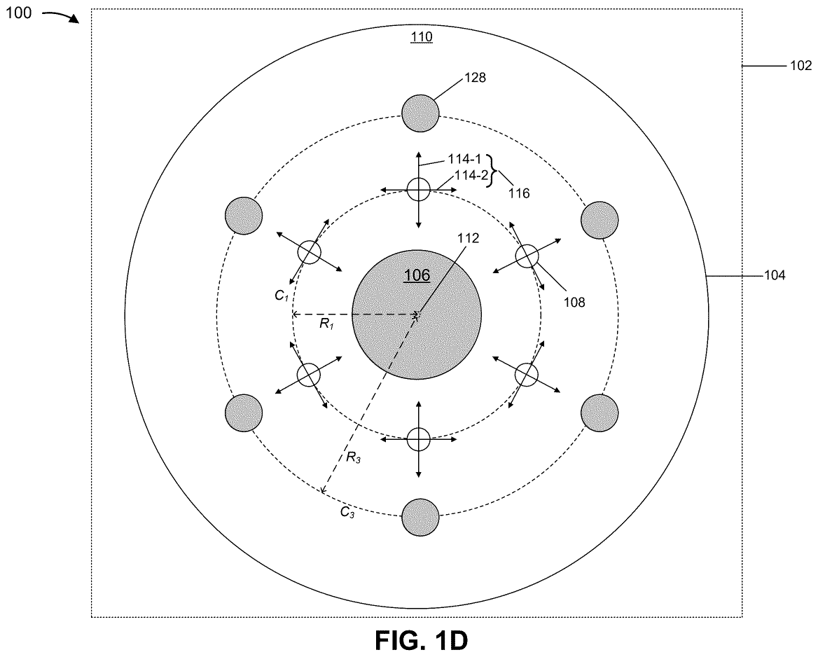

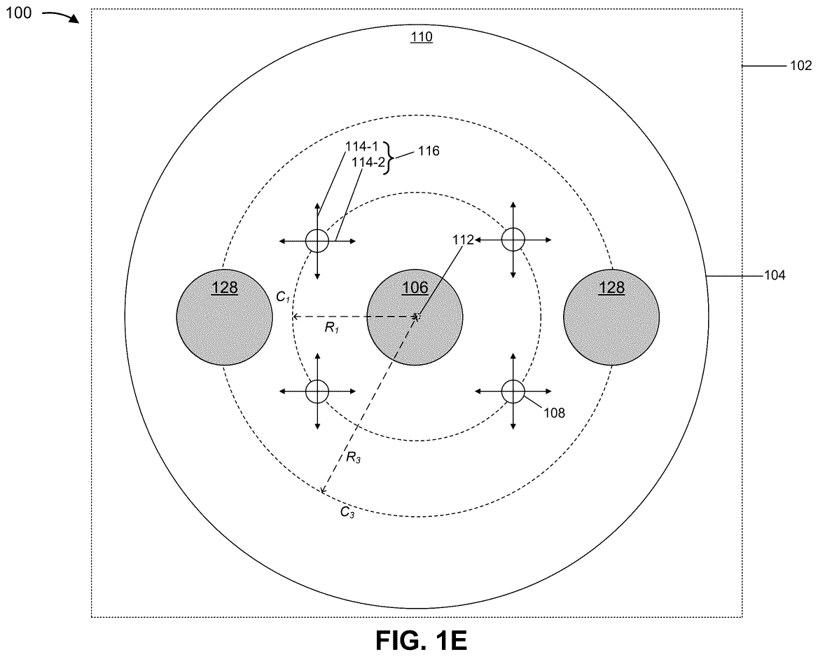

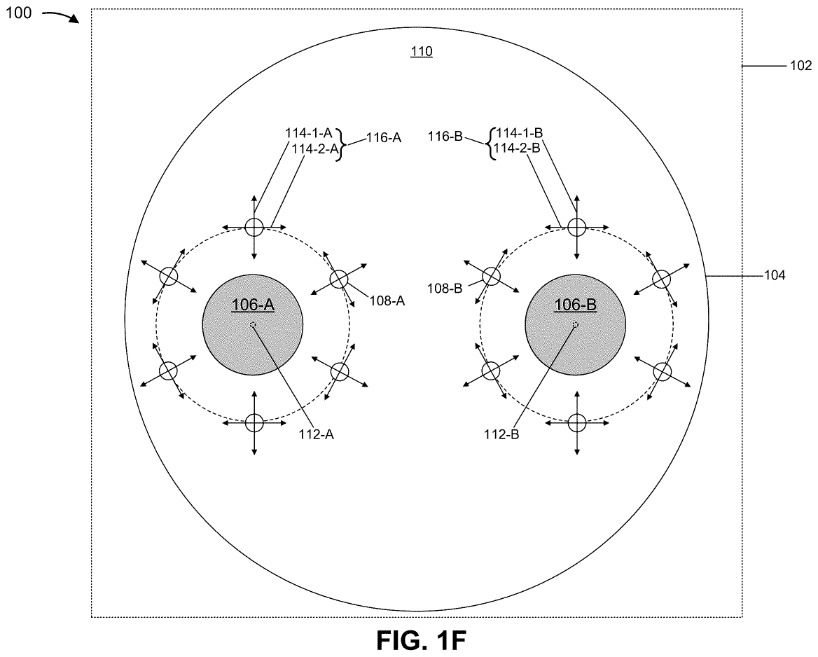

FIGS. 1A-1F are diagrams illustrating example implementations 100 related to a PM multicore fiber that includes an SAP to substantially effect a birefringence in surrounding cores. As shown in FIGS. 1A-1F, the example implementations 100 includes an optical system 102 (e.g., a fiber laser system, a coherent beam combining (CBC) system, and/or an optical amplifier system, among other examples). The optical system 102 comprises a multicore fiber 104, which may include an SAP 106, a plurality of cores 108 (e.g., a set of at least two cores, a set of at least three cores, or so on), and a cladding 110. FIGS. 1A-1F show cross-sectional views of the multicore fiber 104 associated with each example implementation 100. The cross-sectional configuration of the multicore fiber 104 extends through a length of the multicore fiber 104, so the cross-sectional views described herein in relation to FIGS. 1A-1F may be at any point along the length of the multicore fiber 104.

As shown in FIGS. 1A-1F, the multicore fiber 104 may include the SAP 106 and the plurality of cores 108 within the multicore fiber 104 (e.g., within the cladding 110 of the multicore fiber 104). The SAP 106 may be (e.g., at a cross-section of the multicore fiber 104) disc-shaped (e.g., may have a filled, round shape), ring-shaped (e.g., may have a hollow, round shape), or may have another type of shape. Notably, the SAP 106 may include a center 112 (e.g., a center point of the SAP 106). In some implementations, the center 112 of the SAP 106 may be aligned with a center of the multicore fiber 104 (e.g., a center point of the multicore fiber 104 or a center point of the cladding 110), or, alternatively, may not be aligned with the center of the multicore fiber 104. As further shown in FIGS. 1A-1F, each of the plurality of cores 108 may be (e.g., at the cross-section of the multicore fiber 104) disc-shaped, or may have another type of shape. The SAP 106 and the plurality of cores 108 may be embedded in the cladding 110 (e.g., the cladding 110 may be an interstitial component in which the SAP 106 and the plurality of cores 108 are disposed, such as in configurations described herein in relation to FIGS. 1A-1F).

The SAP 106 and the plurality of cores 108 may comprise different materials, and therefore may have different thermal expansion properties from each other, and also from the cladding 110. For example, the SAP 106 may comprise a boron (B) doped glass (e.g., a silica-based glass) and the plurality of cores 108 may comprise ytterbium (Yb) doped glass (e.g., a silica-based glass) while the cladding 110 may comprise an undoped glass (e.g., a silica-based glass). Accordingly, due to the different thermal expansion properties between the SAP 106 and the plurality of cores 108 and/or between the SAP 106 and the cladding 110, a mechanical stress is applied to each core 108 (e.g., as a result of a heated fiber-draw process to create the multicore fiber 104). This stress substantially effects a birefringence in the core 108, as further described herein.

As shown in FIG. 1A, at a cross-section of the multicore fiber 104, the plurality of cores 108 may surround the SAP 106 within the cladding 110. For example, the plurality of cores 108 may surround the SAP 106 in the cladding 110 such that the plurality of cores 108 are equidistant from a center 112 of the SAP 106. That is, the plurality of cores 108 may be disposed on a circumference of an imaginary circle C₁ with a radius R₁ that is centered at the center 112 of the SAP 106 (e.g., each core 108 is positioned at a same radial distance from the center 112 of the SAP 106).

In some implementations, a center-to-center distance between a first core 108 and a second core 108, of the plurality of cores 108, that are adjacent to each other (e.g., the first core 108 and the second core 108 are adjacent cores 108), may be greater than or equal to 2.5 times a maximum of a first diameter of the first core 108 and a second diameter of the second core 108 (e.g., a maximum of respective diameters of the adjacent cores 108). In this way, a likelihood of crosstalk between the first core 108 and the second core 108 (e.g., between the adjacent cores 108) is minimized.

As further shown in FIG. 1A, the SAP 106 (e.g., due to being surrounded by the plurality of cores 108) may apply a mechanical stress to the plurality of cores 108 and may therefore substantially effect a birefringence in the plurality of cores 108 (e.g., the SAP 106 may cause, may primarily cause, the birefringence in the plurality of cores 108). Substantially effecting the birefringence may include any change in the birefringence that causes one or more optical properties of the plurality of cores 108 to be greater than a corresponding negligible threshold, such as a change in a refractive index difference (e.g., that defines the birefringence) that is greater than a negligible refractive index difference threshold (e.g., that may be 0.01×10⁻³, 0.1×10⁻³, or a different amount).

Substantially effecting the birefringence in each core 108 may cause the core 108 to have a first principal axis of polarization 114-1 (e.g., one of a fast axis or a slow axis of polarization) that is radially aligned with the center 112 of the SAP 106, and to have a second principal axis of polarization 114-2 (e.g., the other of the fast axis or the slow axis of polarization) that is orthogonal to the first principal axis of polarization 114-1. The first principal axis of polarization 114-1 and the second principal axis of polarization 114-2 may be referred to, together, as principal axes of polarization 116 of the core 108. Accordingly, in some implementations, a first core 108, of the plurality of cores 108, may have first principal axes of polarization 116 that are not aligned with second principal axes of polarization 116 of a second core 108 of the plurality of cores 108. For example, when the first core 108, the second core 108, and the center 112 of the SAP 106 are not collinear (e.g., are not disposed on a same imaginary line), the first core 108 may have a particular first principal axis of polarization 114-1, of the first principal axes of polarization 116, that is radially aligned with the center 112 of the SAP 106, the second core 108 may have another particular first principal axis of polarization 114-1, of the second principal axes of polarization 116, that is radially aligned with the center 112 of the SAP 106, and the particular first principal axis of polarization 114-1 and the other particular first principal axis of polarization 114-1 may not be aligned (e.g., may not be parallel to each other). As another example, when the plurality of cores 108 includes a set of at least three cores 108, a first core 108, of the set of at least three cores 108, may have first principal axes of polarization 116 that are not aligned with second principal axes of polarization 116 of a second core 108 of the set of at least three cores 108 (e.g., because there exists a first core 108 and a second core 108, of the set of at least three cores, that are not collinear with the center 112 of the SAP 106, and therefore must have non-aligned principal axes of polarization 116). When considering alignment between first principal axes of polarization 116 and second principal axes of polarization 116, a first principal axis of polarization 114-1 of the first principal axes of polarization 116 that corresponds to a fast axis of the first principal axes of polarization 116 could be compared to a first principal axis of polarization 114-1 of the second principal axes of polarization 116 that corresponds to a fast axis of the second principal axes of polarization 116, or a first principal axis of polarization 114-1 of the first principal axes of polarization 116 that corresponds to a slow axis of the first principal axes of polarization 116 could be compared to a first principal axis of polarization 114-1 of the second principal axes of polarization 116 that corresponds to a slow axis of the second principal axes of polarization 116. However, it would be inappropriate to compare the first principal axis of polarization 114-1 of the first principal axes of polarization 116 that corresponds to the slow axis of the first principal axes of polarization 116 to the second principal axis of polarization 114-2 of the second principal axes of polarization 116 that corresponds to the fast axis of the second principal axes of polarization 116 and to compare the the second principal axis of polarization 114-1 of the first principal axes of polarization 116 that corresponds to the first axis of the first principal axes of polarization 116 to the first principal axis of polarization 114-2 of the second principal axes of polarization 116 that corresponds to the slow axis of the second principal axes of polarization 116.

Accordingly, the multicore fiber 104 may be polarization maintaining (e.g., the multicore fiber 104 may be a PM multicore fiber and each core 108 of the plurality of cores 108 may be polarization maintaining). For example, because of the birefringence induced in each core 108 (e.g., by the SAP 106), each core 108 is enabled to maintain polarization of light within that core 108 (e.g., in directions aligned with the principal axes of polarization 116 of the core 108). In some implementations, the birefringence substantially effected in the plurality of cores 108 may be equal across the plurality of cores 108. For example, due to the plurality of cores 108 being equidistant from the center 112 of the SAP 106, the SAP 106 applies an equal (or nearly equal) mechanical stress to each core 108, and the birefringence induced in each core 108 (e.g., by the SAP 106) may be the same (or may be nearly the same, within a tolerance). Put another way, a birefringence field (e.g., of the birefringence) in each core 108 may be the same, or nearly the same, in magnitude and/or distribution but in a direction that may be different (e.g., radially aligned with the center 112 of the SAP 106).

FIG. 1B shows another example implementation 100, that is similar to the example implementation 100 shown in FIG. 1A, where the plurality of cores 108 surround the SAP 106 within the cladding 110 (e.g., such that the plurality of cores 108 are equidistant from the center 112 of the SAP 106), and the SAP 106 is ring-shaped. Similar to the disc-shaped SAP 106 described in relation to FIG. 1A, the ring-shaped SAP 106 (e.g., due to being surrounded by the plurality of cores 108) may apply a mechanical stress to the plurality of cores 108 and may therefore substantially effect a birefringence in the plurality of cores 108 (e.g., the SAP 106 may cause, or may primarily cause, the birefringence in the plurality of cores 108). Substantially effecting the birefringence in each core 108 may cause the core 108 to have principal axes of polarization 116 that includes a first principal axis of polarization 114-1 (e.g., one of a fast axis or a slow axis of polarization) that is radially aligned with the center 112 of the SAP 106, and a second principal axis of polarization 114-2 (e.g., the other of the fast axis or the slow axis of polarization) that is orthogonal to the first principal axis of polarization 114-1. Accordingly, the multicore fiber 104 may be polarization maintaining (e.g., the multicore fiber 104 may be a PM multicore fiber and each core 108 of the plurality of cores 108 may be polarization maintaining), as described above. Further, the birefringence substantially effected in the plurality of cores 108 may be equal across the plurality of cores 108 (e.g., due the plurality of cores 108 being equidistant from the center 112 of the SAP 106).

FIG. 1C shows another example implementation 100 that is similar to the example implementation 100 shown in FIG. 1A, where the multicore fiber 104 further includes (e.g., at a cross-section of the of the multicore fiber 104) another SAP 118 (e.g., a ring-shaped SAP) and a set of one or more cores 120 within the cladding 110. The other SAP 118 may include a center 122 (e.g., a center point of the other SAP 118), which may be aligned with the center 112 of the SAP 106. The other SAP 118 and the one or more cores 120 may comprise same or similar materials as the SAP 106 and the plurality of cores 108, respectively. Therefore, the other SAP 118 and the one or more cores 120 may have different thermal expansion properties from each other, from the SAP 106, the plurality of cores 108 and/or from the cladding 110. Accordingly, due to the different thermal expansion properties between the other SAP 118 and the one or more cores 120 and/or between the other SAP 118 and the cladding 110, a mechanical stress is applied in each core 120 (e.g., as a result of a heated fiber-draw process to create the multicore fiber 104). This mechanical stress substantially effects a birefringence in the core 120, as further described herein.

As shown in FIG. 1C, the other SAP 118 may surround the SAP 106 and the plurality of cores 108 because the other SAP 118 is ring-shaped, and the set of one or more cores 120 may surround the SAP 106, the plurality of cores 108, and the other SAP 118 (e.g., within the cladding 110). For example, the set of one or more cores 120 may surround the SAP 106, the plurality of cores 108, and the other SAP 118 such that the set of one or more cores 120 are equidistant from the center 122 of the other SAP 118. That is, the set of one or more cores 120 may be disposed on a circumference of an imaginary circle C₂ with a radius R₂ (e.g., where R₂>R₁) that is centered at the center 122 of the other SAP 118 (e.g., each core 120 is positioned at a same radial distance from the center 122 of the other SAP 118).

In some implementations, a center-to-center distance between a first core 120 and a second core 120, of the set of one or more cores 120, that are adjacent to each other (e.g., the first core 120 and the second core 120 are adjacent cores 120), may be greater than or equal to 2.5 times a maximum of a first diameter of the first core 120 and a second diameter of the second core 120 (e.g., a maximum of respective diameters of the adjacent cores 120). In this way, a likelihood of crosstalk between the first core 120 and the second core 120 (e.g., between the adjacent cores 120) is minimized.

As further shown in FIG. 1C, the other SAP 118 (e.g., due to being surrounded by the set of one or more cores 120) may apply a mechanical stress to the set of one or more cores 120 and may therefore substantially effect a birefringence in the the set of one or more cores 120 (e.g., the other SAP 118 may cause, or may primarily cause, the birefringence in the set of one or more cores 120). Additionally, because the other SAP 118 surrounds (e.g., completely surrounds) the plurality of cores 108, the other SAP 118 may not induce (or may only minimally induce) a birefringence in the plurality of cores 108. Accordingly, the birefringence induced in the plurality of cores 108 by the SAP 106, as described herein in relation to FIG. 1A, may not be affected by the other SAP 118 (or may be only minimally affected).

The other SAP 118 substantially effecting the birefringence in each core 120 may cause the core 120 to have a first principal axis of polarization 124-1 (e.g., one of a fast axis or a slow axis of polarization) that is radially aligned with the center 122 of the other SAP 118, and to have a second principal axis of polarization 124-2 (e.g., the other of the fast axis or the slow axis of polarization) that is orthogonal to the first principal axis of polarization 124-1. The first principal axis of polarization 124-1 and the second principal axis of polarization 124-2 may be referred to, together, as principal axes of polarization 126 of the core 120.

In some implementations, a core 108, of the plurality of cores 108, may have principal axes of polarization 116 that are aligned with principal axes of polarization 126 of a core 120 of the set of one or more cores 120. Additionally, or alternatively, a first core 120, of the set of one or more cores 120, may have first principal axes of polarization 126 that are not aligned with second principal axes of polarization 126 of a second core 120 of the set of one or more cores 120. For example, when the first core 120, the second core 120, and the center 122 of the other SAP 118 are not collinear (e.g., are not disposed on a same imaginary line), the first core 120 may have a particular first principal axis of polarization 124-1, of the first principal axes of polarization 126, that is radially aligned with the center 122 of the other SAP 118, the second core 120 may have another particular first principal axis of polarization 124-1, of the second principal axes of polarization 126, that is radially aligned with the center 122 of the other SAP 118, and the particular first principal axis of polarization 124-1 and the other particular first principal axis of polarization 124-1 may not be aligned (e.g., may not be parallel to each other).

Accordingly, the multicore fiber 104 may be polarization maintaining for both the plurality of cores 108 and the set of one or more cores 120 (e.g., the multicore fiber 104 may be a PM multicore fiber and each core 108 of the plurality of cores 108 and each core 120 of the set of cores 120 may be polarization maintaining). For example, because of the birefringence induced in each core 120 (e.g., by the other SAP 118), each core 120 is enabled to maintain polarization of light within that core 120 (e.g., in directions aligned with the principal axes of polarization 126 of the core 120), and because of the birefringence induced in each core 108 (e.g., by the SAP 106), each core 108 is enabled to maintain polarization of light within that core 108 (e.g., in directions aligned with the principal axes of polarization 116 of the core 108). In some implementations, the birefringence substantially effected in the set of one or more cores 120 may be equal across the set of one or more cores 120. For example, due to the set of one or more cores 120 being equidistant from the center 122 of the other SAP 118, the other SAP 118 applies an equal (or nearly equal) mechanical stress to each core 120, and the birefringence induced in each core 120 may be the same (or may be nearly the same, within a tolerance).

FIG. 1D shows another example implementation 100 that is similar to the example implementation 100 shown in FIG. 1A, where the multicore fiber 104 further includes (e.g., at a cross-section of the of the multicore fiber 104) one or more other SAPs 124 (e.g., one or more disc-shaped SAPs) within the cladding 110. The one or more other SAPs 124 may comprise a same or similar material as the SAP 106. Therefore, the one or more other SAPs 124 and the plurality of cores 108 may have different thermal expansion properties.

As shown in FIG. 1D, the one or more other SAPs 128 may surround the SAP 106 and the plurality of cores 108. For example, the one or more other SAPs 128 may surround the SAP 106 and the plurality of cores 108 such that the one or more other SAPs 128 are equidistant from the center 112 of the SAP 106. That is, the one or more other SAPs 128 may be disposed on a circumference of an imaginary circle C₃ with a radius R₃ (e.g., where R₃>R₁) that is centered at the center 112 of the SAP 106 (e.g., each other SAP 128 is positioned at a same radial distance from the center 112 of the SAP 106).

In some implementations, a particular other SAP 128 may be associated with a particular core 108 of the plurality of cores 108. For example, as shown in FIG. 1D, the particular other SAP 128, the particular core 108, and the center 112 of the SAP 106 may be collinear (e.g., at the cross-section of the multicore fiber 104) and the particular core 108 may be positioned between the particular other SAP 128 and the SAP 106. Accordingly, the particular other SAP 128 may also apply a mechanical stress to the particular core 108 and may therefore substantially effect the birefringence in the particular core 108 that is (in coordination) substantially effected, in the particular core 108, by the SAP 106 (e.g., because the SAP applies a mechanical stress to the particular core 108, as described elsewhere herein). For example, the particular other SAP 128 may be positioned to increase a mechanical stress in the particular core 108 (e.g., due to the different thermal expansion properties between the other SAP 128 and the particular core 108 and/or between the other SAP 128 and the cladding 110) that is predominantly created by the SAP 106, which enhances the birefringence substantially effected in the particular core 108. Accordingly, the particular core 108 may have principal axes of polarization 116 that includes a first principal axis of polarization 114-1 (e.g., one of a fast axis or a slow axis of polarization) that is radially aligned with the center 112 of the SAP 106, and to have a second principal axis of polarization 114-2 (e.g., the other of the fast axis or the slow axis of polarization) that is orthogonal to the first principal axis of polarization 114-1.

FIG. 1E shows another example implementation 100 that is similar to the example implementation 100 shown in FIG. 1D, wherein each of the one or more other SAPs 128 is associated with two or more cores 108 of the plurality of cores 108. For example, another SAP 128 may be positioned such that the SAP 106 and the other SAP 128, individually, and in association with each other, apply a mechanical stress to two or more cores 108, of the plurality of cores 108, and may therefore substantially effect a birefringence in the two or more cores 108 of the plurality of cores 108. Accordingly, the one or more other SAPs 128 may be positioned (e.g., on the circumference of the imaginary circle C₃) such that the birefringence is induced in the plurality of cores 108 such that respective principal axes of polarization 116 of the plurality of cores 108 are not radially aligned with the center 112 of the SAP 106. For example, as shown in FIG. 1E, the SAP 106, in association with and the one or more other SAPs 128, may be configured to substantially effect the birefringence in the plurality of cores 108 such that respective principal axes of polarization 116 of the plurality of cores 108 are aligned (e.g., with respective first principal axes of polarization 114-1 aligned in a vertical direction and with respective second principal axes of polarization 114-2 aligned in a horizontal direction, as shown in FIG. 1E).

FIG. 1F shows another example implementation 100 that is similar to the example implementation 100 shown in FIG. 1A, where the multicore fiber 104 includes (e.g., at a cross-section of the of the multicore fiber 104) a first SAP 106-A and a plurality of first cores 108-A that surround the first SAP 106-A within the cladding 110 (e.g., in a similar manner as that described herein in relation to FIG. 1A), and a second SAP 106-B and a plurality of second cores 108-B that surround the second SAP 106-B within the cladding 110 (e.g., in a similar manner as that described herein in relation to FIG. 1A). The first SAP 106-A may have a center 112-A and the second SAP 106-B may have a center 112-B, both of which may be offset from a center of the multicore fiber 104.

As shown in FIG. 1F, the first SAP 106-A (e.g., due to being surrounded by the plurality of first cores 108-A) may apply a mechanical stress to the plurality of first cores 108-A and may therefore substantially effect a first birefringence in the plurality of first cores 108-A (e.g., the first SAP 106-A may cause, or may primarily cause, the first birefringence in the plurality of first cores 108-A). Substantially effecting the first birefringence in each first core 108-A may cause each first core 108-A to have principal axes of polarization 116-A that includes a first principal axis of polarization 114-1-A (e.g., one of a fast axis or a slow axis of polarization) that is radially aligned with the center 112-A of the first SAP 106-A, and a second principal axis of polarization 114-2-A (e.g., the other of the fast axis or the slow axis of polarization) that is orthogonal to the first principal axis of polarization 114-1-A. Accordingly, in some implementations, a first core 108-A, of the plurality of first cores 108-A, may have first principal axes of polarization 116-A that are not aligned with second principal axes of polarization 116-A of another first core 108-A of the plurality of first cores 108-A, in a similar manner as described above.

As further shown in FIG. 1F, the second SAP 106-B (e.g., due to being surrounded by the plurality of second cores 108-B) may apply a mechanical stress to the plurality of second cores 108-B and may therefore substantially effect a second birefringence in the plurality of second cores 108-B (e.g., the second SAP 106-B may cause, or may primarily cause, the second birefringence in the plurality of second cores 108-B). Substantially effecting the second birefringence in each second core 108-B may cause each second core 108-B to have principal axes of polarization 116-B that includes a first principal axis of polarization 114-1-B (e.g., one of a fast axis or a slow axis of polarization) that is radially aligned with the center 112-B of the second SAP 106-B, and a second principal axis of polarization 114-2-B (e.g., the other of the fast axis or the slow axis of polarization) that is orthogonal to the first principal axis of polarization 114-1-B. Accordingly, in some implementations, a second core 108-B, of the plurality of second cores 108-B, may have first principal axes of polarization 116-B that are not aligned with second principal axes of polarization 116-B of another second core 108-B of the plurality of second cores 108-B, in a similar manner as described above.

FIGS. 1A-1F are provided as an example. Other examples may differ from what is described with regard to FIGS. 1A-1F.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” “left,” “right,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical system, comprising:
a multicore fiber that includes:
a cladding;
a stress applying part (SAP); and
a set of at least three cores that, at a cross-section of the multicore fiber, are equidistant from a center of the SAP,
wherein the SAP substantially effects a birefringence in the set of at least three cores.

2. The optical system of claim 1, wherein a first core, of the set of at least three cores, has first principal axes of polarization that are not aligned with second principal axes of polarization of a second core of the set of at least three cores.

3. The optical system of claim 2, wherein:
a particular first principal axis of polarization, of the first principal axes of polarization, is radially aligned with the center of the SAP;
another particular first principal axis of polarization, of the second principal axes of polarization, is radially aligned with the center of the SAP; and
the particular first principal axis of polarization and the other particular first principal axis of polarization are not aligned.

4. The optical system of claim 1, wherein the birefringence is equal across the set of at least three cores.

5. The optical system of claim 1, wherein the SAP, at the cross-section of the multicore fiber, is one of:
disc-shaped, or
ring-shaped.

6. The optical system of claim 1, wherein the multicore fiber further includes:
another SAP that, at the cross-section of the multicore fiber, surrounds the SAP and the set of at least three cores; and
a set of one or more cores that, at the cross-section of the multicore fiber, surround the other SAP and are equidistant from a center of the other SAP,
wherein the other SAP substantially effects a birefringence in the set of one or more cores.

7. The optical system of claim 1, wherein the multicore fiber further includes:
another SAP associated with a particular core, of the set of at least three cores, wherein:
the other SAP, the particular core, and a center of the SAP are collinear at the cross-section of the multicore fiber, and
the particular core is positioned between the other SAP and the SAP at the cross-section of the multicore fiber.

8. The optical system of claim 1, wherein the multicore fiber further includes:
another SAP; and
another set of at least three cores that, at the cross-section of the multicore fiber, are equidistant from a center of the other SAP,
wherein the other SAP substantially effects a birefringence in the other set of at least three cores.

9. The optical system of claim 1, wherein the multicore fiber further includes:
a first other SAP; and
a second other SAP, wherein;
the SAP, in association with the first other SAP and the second other SAP, substantially effect the birefringence in the set of at least three cores such that respective principal axes of polarization of the set of at least three cores are aligned.

10. An optical system, comprising:
a multicore fiber that includes:
a cladding;
a stress applying part (SAP); and
a set of at least three cores that surround the SAP,
wherein the SAP substantially effects a birefringence in the set of at least three cores, and
wherein respective principal axes of polarization of the set of at least three cores are radially aligned with a center of the SAP.

11. The optical system of claim 10, wherein the set of at least three cores are equidistant from a center of the SAP.

12. The optical system of claim 10, wherein a first core, of the set of at least three cores, has first principal axes of polarization that are not aligned with second principal axes of polarization of a second core of the set of at least three cores.

13. The optical system of claim 1, wherein the birefringence is equal across the set of at least three cores.

14. The optical system of claim 10, wherein the multicore fiber further includes:
another SAP that surrounds the set of at least three cores; and
a set of one or more cores that surround the other SAP.

15. The optical system of claim 10, wherein the multicore fiber further includes:
another SAP, wherein:
a particular core is positioned closer to the SAP than the other SAP is positioned to the SAP.

16. The optical system of claim 10, wherein the multicore fiber further includes:
another SAP; and
another plurality of cores that surround the other SAP,
wherein the other SAP substantially effect a birefringence in the other plurality of cores.

17. A multicore fiber, comprising:
a cladding;
a stress applying part (SAP); and
a plurality of cores that are equidistant from a center of the SAP,
wherein the SAP substantially effects a birefringence in the plurality of cores, and
wherein a center of the SAP, and a first core and a second core, of the plurality of cores, are not collinear.

18. The multicore fiber of claim 17, wherein the first core has first principal axes of polarization that are not aligned with second principal axes of polarization of the second core.

19. The multicore fiber of claim 17, wherein the first core has a first principal axis of polarization that is radially aligned with the center of the SAP and the second core has a second principal axis of polarization that is radially aligned with the center of the SAP.

20. The multicore fiber of claim 17, wherein the first core has first principal axes of polarization that are aligned with second principal axes of polarization of the second core.
